(19) United States
(12) Patent Application Publication
(10) Pub. No.: US 2024/0035680 A1
(43) Pub. Date: Feb. 1, 2024

(54) Active Thermal Transportation System (ATTS)

(71) Applicants: Cody Johnson, Nashville, TN (US); Kenneth Lowrence, Schaumburg, IL (US)

(72) Inventors: Cody Johnson, Nashville, TN (US); Kenneth Lowrence, Schaumburg, IL (US)

(21) Appl. No.: 17/816,721

(22) Filed: Aug. 1, 2022

(51) Int. Cl. F24F 5/00

(52) U.S. Cl. CPC F24F 5/0021; F24F 2221/17

(57) ABSTRACT

A container and rail assembly system which holds phase change material (PCM). The container is comprised of a cuboidal shape akin to pizza box and the rail assembly incorporates rails as attachment mechanisms to affix the containers to surfaces within the conditioned space. Said container and rail assembly place the PCM in a location within the conditioned space that is not used or less likely to be used. Said container and rail assembly also place the PCM within the airflow of the conditioned space where the PCM is in closest proximity with the air that is emanating from the heating or cooling system.

### CROSS REFERENCE TO RELATED APPLICATION

63/203,827

### FIELD OF INVENTION

The present invention relates to improvements in the containers for phase change material (PCM) and methods of using specialized containers for PCM to increase the efficacy of the PCM's temperature mitigating properties.

### BACKGROUND OF THE TECHNOLOGY

Phase Change Material (PCM) has existed for quite a while now, but the use of PCM in conditioned spaces for its air temperature regulating properties is a relatively recent development. Containers capable of holding PCM exist, but specialized containers for specific applications are needed and have yet to be developed. Just as there are many kinds of HVAC systems to heat or cool various types of facilities of all shapes and sizes, there will be many containers for PCM of all configurations and sizes for various applications depending on the particular needs of that space.

Presently, containers for PCM exist for the purpose of containing the PCM within a conditioned space. To name a few, the PCM filled blanket as well as the PCM filled panel are two of the most notable. The PCM blanket exists as a sheet of fluid filled pouches that resemble bubble wrap or oversized ketchup packages. The PCM panel exists as a hollow plastic container that resembles an ice pack used in lunch boxes. Though both the PCM blanket as well as the PCM panel have uses in various applications, for some applications neither are the best choice. For example, either the PCM blanket or the PCM panel are great in applications involving drop ceiling. The blanket can be placed above the ceiling tiles or the panel can replace the tiles themselves. However, neither of these containers are the best option for cold storage. For an application like cold storage, the container for the PCM needs to be able to mount or suspend from the ceiling in front of the evaporators.

Therefore, the need exists for improved PCM container designs that are applicable to specific installations providing the maximum benefit in those particular scenarios.

### SUMMARY OF THE INVENTION

The present invention is intended to provide an improved container mechanism and system for deploying PCM in conditioned spaces like, but not limited to, the refrigerated trailers of tractor-trailer rigs, walk-in refrigerators or freezers, or any sort of heated or cooled space. In order to maximize the temperature regulating effects of the PCM while also conserving usable space, the present invention is designed to fit securely on the roof or walls of the semi trailer, refrigerator, freezer or conditioned space minimizing the cancellation of usable space, yet positioned adjacent to the heating or cooling mechanism of the conditioned space. It is also contemplated that the present invention may be inserted into the walls of the conditioned space to further maximize on space as well as prevent damage to the containers holding PCM. Furthermore, by creating this proximity of the present invention to the conditioned air moving off the heating or cooling mechanism of the air conditioning system, the effects of the PCM within the present invention are thereby enhanced as the PCM is charged by conditioned air at its coldest or warmest temperature.

The present invention can provide one or more advantages compared to existing PCM containers. The present invention places the PCM within closest proximity to the heating and cooling mechanism of the conditioned space's air conditioning system, while also positioning the PCM on the roof or walls of the conditioned space where no precious storage or utility space is consumed. By situating the present in close proximity to the air conditioning mechanism, but also outside or on the fringe of usable space, the effects of the PCM are enhanced while not diminishing carrying or operating capacity of the trailer, fridge, freezer, or other conditioned space. For instance, an embodiment of the present invention made to mount on a semi trailer's roof or walls can maintain that refrigerated trailer at the desired temperature for longer periods of time without the use of active heating and cooling systems because of its proximity within the trailer to the conditioned air traveling through that trailer from the air conditioning system.

Additionally, the present invention is designed to offer bolt-on functionality thereby making installation as simple as attaching the rail assembly to the roof or walls of the conditioned space. Where the rail assembly and PCM container are part of a separable design, meaning the rail assembly and PCM container are not one cohesive part but two separate parts, the rail assembly simply adheres to the roof or walls of the conditioned space by bolts, screws, welds, or other attachment mechanisms and then the PCM container or containers slide into the rail assembly. Because conditioned spaces can vary in size, one embodiment of the present invention is designed to be comprised of components that attach to one another in a streamline fashion, thereby allowing the present invention to increase in length incrementally across the roof or walls of the conditioned space.

Furthermore, because of the present invention's enhanced surface area design, where the PCM containers within the rail assembly span the length and width of the trailer, the PCM within the present invention is able to interact with ambient air more effectively as the conditioned air flows across the present invention's surface. By designing the present invention in such a way that maximum surface area is obtained, the effects of the PCM are enhanced because more air interacts with more PCM.

Lastly, because of its interlinking design and ability to fasten to the roof of the trailer, the present invention is a more efficient alternative to other PCM containers like the panel or blanket, providing the same or more BTUs, while allowing quick installation, minimal consumption of usable space, and secure placement.

In most respects, an ATTS described herein comprises a single unit or series of rail assemblies that mount to the roof or walls of refrigerated spaces where the rail assemblies are secured in such a way to hold specially designed PCM filled containers, which may be permanently affixed to the rail assembly or removable from the rail assembly. The ATTS design allows for maximum surface area to volume ratio of the PCM filled containers leading to increased efficacy of the PCM.

The ATTS consists of a rail assembly that mounts to the roof of a refrigerated space by use of various attachment mechanisms such as, but not limited to, bolts, screws, glue, welds, or any other attachment mechanism able to hold the weight of the ATTS. The rail assembly consists of two rails of fixed length designed to exist at a fixed distance apart from one another for the purpose of holding PCM filled containers securely to the roof or walls of the conditioned space. The rails within the rail assembly can be made of any material able to hold the weight and shape of the PCM containers. The PCM containers, designed to fit securely into the rail assembly, may assume a variety of shapes such as, but not limited to, a flattened cuboidal shape with a “swiss cheese” like internal structure that creates a fixed structure for holding the PCM while encompassing a shape that maximizes the surface area to volume ratio of the container. It is also contemplated that the PCM container may take the shape of a honeycomb, or coil, or assume the arrangement of fans within a radiator. The ATTS may be comprised of a multi-component system where the PCM containers are separable from the rail assembly having the capability of being removed and reinserted into the rail assembly, or a single-component system where the PCM containers are permanently fixed to the rail assembly and the unit as a whole mounts to the roof or wall of the conditioned space as a complete product.

### DESCRIPTION OF THE DRAWINGS

FIG. 1 is a perspective view of the ATTS by which the rail assembly is represented by two individual rails situated adjacent to the PCM containers with the PCM containers existing between the two rails; a PCM container is represented by cuboidal figures with circular holes; and the attachment mechanism is represented by the perforations within the rails.

FIG. 2 is a perspective view of the ATTS illustrating most of the same aspects as detailed in FIG. 1, but highlighting the ability of the rail assembly and PCM containers of FIG. 1 to be arranged into a series of rail assembly and PCM containers situated side by side.

FIG. 3 is a perspective view of the ATTS illustrating the placement of an ATTS on the ceiling of a conditioned space, whereby the ATTS is within the airflow flyway of the air conditioning system but not consuming space needed to store the cargo.

FIG. 4 is a perspective view of the ATTS illustrating a different manifestation of the ATTS where the PCM container is permanently attached to rails, as depicted, and where the rails comprise a coupling mechanism allowing one ATTS to attach to another.

FIG. 4A is an exploded view of the ATTS from FIG. 4 illustrating the coupling mechanism by magnetism, where the magnet is attached to a swiveling device that is permanently affixed to the end of the rail.

FIG. 5 is a perspective view of the ATTS illustrating a different manifestation of the ATTS where the PCM container is permanently attached to rails, as depicted, and where the rails comprise an attachment mechanism allowing one ATTS to attach to another.

### DETAILED DESCRIPTION OF THE INVENTION

Implementations described herein can be understood more readily by reference to the following detailed descriptions, examples, and drawings. Elements, apparatus, and methods described herein, however, are not limited to the specific implementations presented in the detailed description, examples, and drawings. It should be recognized that these implementations are merely illustrative of the principles of the present disclosure. Numerous modifications and adaptations will be readily apparent to those of skill in the art without departing from the spirit and scope of this disclosure.

In one aspect an ATTS is described herein. Exemplary embodiments of such ATTS will now be more fully described with reference to the figures.

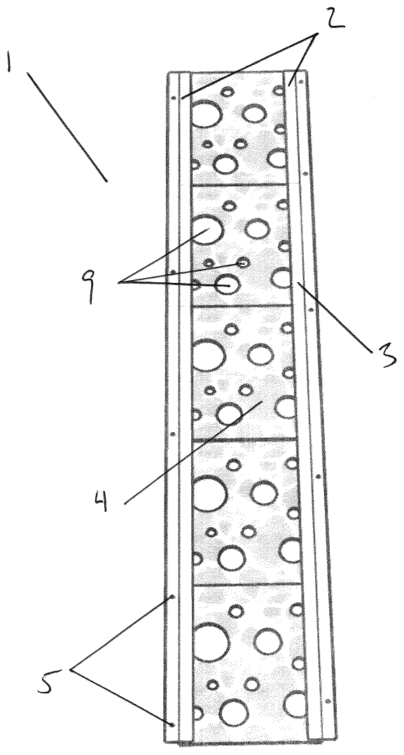

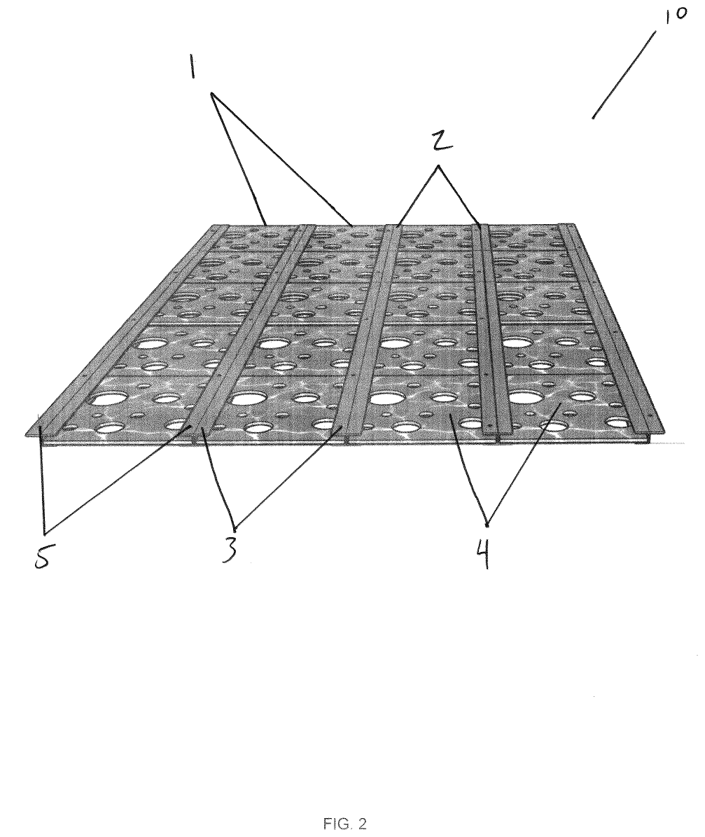

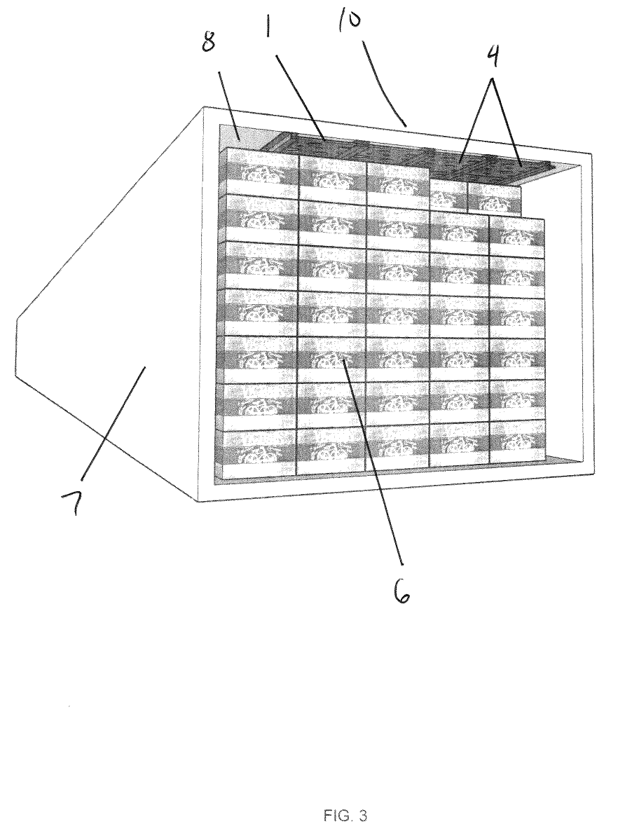

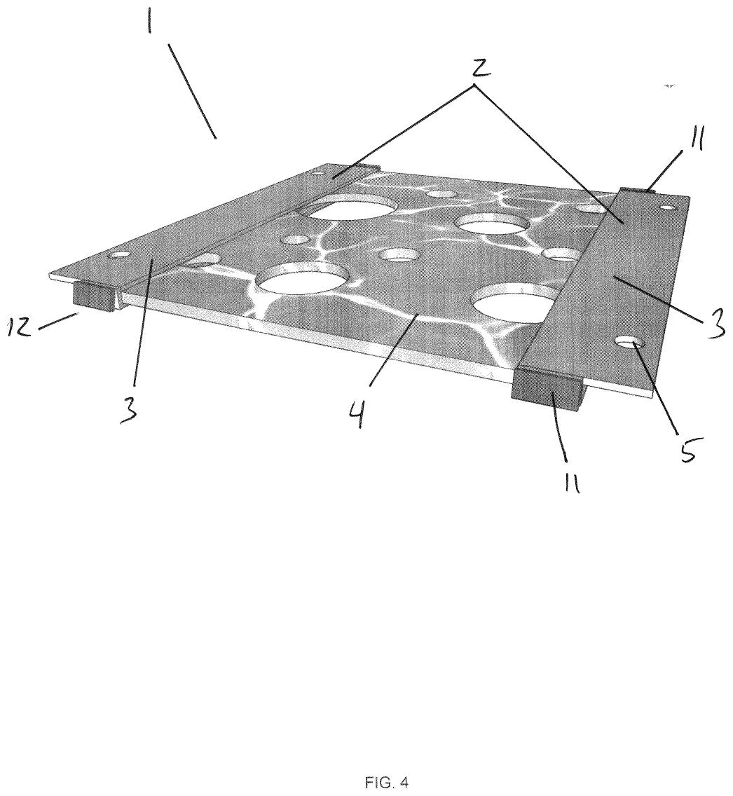

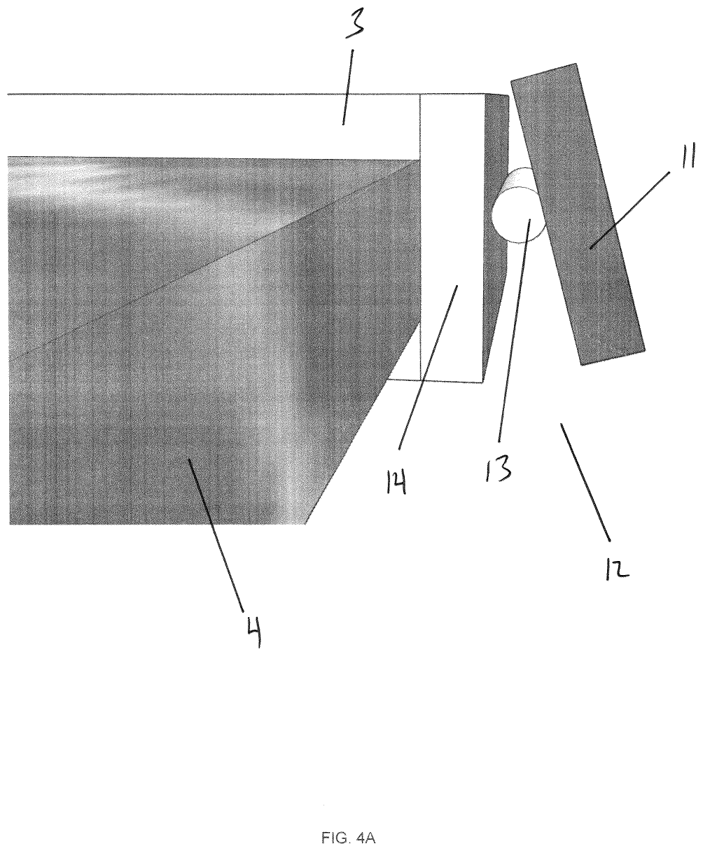

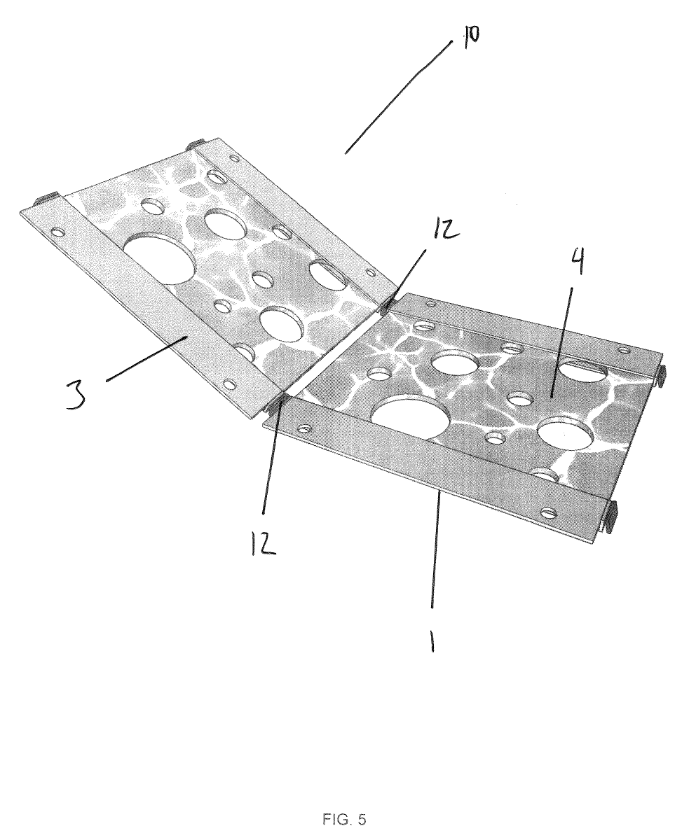

FIG. 1 illustrates a perspective view of an ATTS 1 displaying the rail assembly 2, an individual rail 3, multiple PCM containers 4, air passages within the PCM container 9, and the attachment mechanism 5 for affixing the ATTS 1 to the surfaces of an air conditioned space. FIG. 2 illustrates a perspective view of multiple ATTSs 1 combined to display the container system 10 while also displaying multiple rail assemblies 2, multiple individual rails 3, multiple PCM containers 4, and the attachment mechanisms 5. FIG. 3 illustrates a perspective view of one type of conditioned space 7 holding cargo 6 that is installed with PCM containers 4 using the container system 10 comprising four ATTSs 1 mounted on the ceiling 8 of the conditioned space 7. FIG. 4 illustrates another embodiment of an ATTS 1 where the PCM container 4 is permanently attached to the rails 3, as depicted, and where the rails 3, and consequently the rail assembly 2, includes a coupling mechanism 12, illustrated by magnets 11, allowing one ATTS 1 to attach to another. FIG. 4A illustrates more fully the coupling mechanism 12 comprising a magnet 11, a swivel device 13, and a base 14, where the swivel device is permanently affixed to the end of a rail 3 via the base 14. FIG. 5 illustrates the coupling action of the embodiment of an ATTS 1 described in FIGS. 4 and 4A where the PCM container 4 of the ATTS 1 is permanently attached to rails 3, and where the rails 3 include a coupling mechanism 12 allowing one ATTS 1 to attach to another, thus displaying another embodiment of a container system 10.

With reference to FIGS. 1, 2, and 3, the attachment mechanism 5 is a component of the ATTS 1 by which the ATTS 1 is secured to the ceiling 8 or wall of a refrigerated space. This attachment mechanism 5 may assume various shapes and contemplates various connection methods from bolt on, to screw on, to glue on, to weld on, etc. The attachment mechanism 5 is connected to or is a part of the rail assembly 2. The rail assembly 2 is a frame-like structure consisting of two or more individual rails 3. In one embodiment, the rail assembly 2 doubles as the frame or support for the general structure of the ATTS 1 as well as the component of the ATTS 1 which holds the PCM containers 4.

With reference to FIGS. 1, 2, and 4A, an individual rail 3 is an elongated C-shaped (as depicted) or L-shaped (as also contemplated) structure made of a rigid material such as, but not limited to, metal, plastic, etc. Depending on the needs of a given conditioned space, it is contemplated that an end cap could be added to the ends of the rail assembly 2 to secure the PCM container 4 within the rail assembly 2, much like the base 14 in FIG. 4A. One embodiment of the PCM container 4 is a “swiss cheese” shaped rectangular cuboid which has a hollow center and open cavities or air passages 9. As illustrated by the PCM containers 4 depicted in FIGS. 1 and 2, an individual PCM container 4 embodies a radiator-like design where it has the capability to hold a fluid like the PCM, but also allow air to pass through its cavities or air passages 9. It is contemplated that the PCM container 4 may embody varying shapes and dimensions with varying shapes and styles of air passages 9 from PCM containers 4 that look as depicted in FIG. 1 (Swiss cheese) to containers that look like actual radiators, to containers that look like honeycombs of a bee hive, to containers that have no air passages, etc.

The ATTS 1 may manifest itself in at least two embodiments. In one embodiment, the ATTS 1 is one solid piece (solid assembly ATTS) where the PCM containers 4 are permanently fixed into the rail assembly 2, as depicted in FIGS. 4, 4A, and 5. In this embodiment of an ATTS, the PCM containers 4 are not removable from the rail assembly 2. With regard to the solid assembly ATTS 1, the individual components of the ATTS system 10 are the individual ATTS 1 units as illustrated in FIG. 4. In this embodiment, it is contemplated that the individual solid assembly ATTS 1 units couple to each other by virtue of the coupling mechanism 12 to create an ATTS system 10. The coupling mechanism 12 may be achieved by a variety of attachment methods from bolt on, to glue on, to weld on, to hook on, etc., but is represented in FIGS. 4, 4A, and 5, by magnetic attachment. With reference to FIGS. 4 and 4A, the magnet 11 is attached to a swiveling device 13 which is attached to a base 14 which is attached to the rail assembly 2. The swiveling device 13 allows for flexibility between coupled ATTS 1 units, whereas the base 14 provides an attachment point for the swivel device which in turn attaches to the magnet 11 or other coupling style. With reference to FIGS. 3, 4, and 4A, the coupling mechanism 12 for connecting individual ATTS 1 units to each other is not to be confused with attachment mechanism 5 which is for affixing the ATTS 1 units to the surfaces of conditioned spaces 7.

In another embodiment, the ATTS 1 may consist of a rail assembly 2 and PCM containers 4 as distinct, separable parts of the whole ATTS 1 where the PCM containers 4 may be removed from and inserted back into the rail assembly 2, as depicted in FIGS. 1 and 2.

Having described the present invention, what is claimed is:

1. A container and rail assembly comprising:
a. A rail assembly, characterized in that said rail assembly is comprised of individual rails
b. One or more PCM container(s),
c. One or more attachment mechanism(s),
d. And one or more coupling mechanism(s).

2. The rail assembly from claim 1 which is comprised of two or more C-shaped or L-shaped rails, where said rails are made of any type of rigid material such as, but not limited to, metal, plastic, etc., where said rails may embody perforations or protrusions of varying size and shape to aid in attaching the rail assembly to a surface, and where said rail assembly is capable of suspension from the walls, ceiling, or floors of a structure.

3. The PCM container from claim 1 where said container is cuboidal in shape embodying a hollow inner space created by walls that make up the container's perimeter, where the inner hollow space is capable of being filled with a substance like PCM, where said container may embody perforations of varying size and shape that traverse the depth of the PCM container creating passageways through the container (meaning holes through the container), where said container may also embody a regular cuboidal shape with no perforations, irregularities or indentations in the lateral faces of the container (meaning no holes through the container), and where said container is supported by and attached to the rails of the rail assembly two rails being on opposite sides of the container.

4. The attachment mechanism from claim 1 where said attachment mechanism is capable of fixing the rail assembly and PCM container(s) from claims 2 and 3 respectively to the ceiling, walls, floors, or other flat surfaces of a structure, where said attachment mechanism may manifest as, but is not limited to, a bolt-on, screw-on, weld-on, glue-on, magnetize-on configuration, or any such attachment configuration capable of affixing the rail assembly to a surface, and where said attachment mechanism exists within or upon the rails of the rail assembly.

5. The rails from claim 1 where said rails may manifest in a variety of shapes and sizes, where said rails embody, but are not limited to, a C-shaped or L-shaped configuration, where said rails embody an attachment mechanism from claim 4 on a lateral surface that may manifest as, but is not limited to, perforations (or holes) allowing for either bolts, screws, or some other attachment mechanism or combination of attachment mechanisms to penetrate through the space created by the perforation to affix the rail, and thus the rail assembly, to a surface, or otherwise support the rail assembly.

6. The container and rail assembly that is essentially what is claimed in claims 1 through 5, characterized in that said container and rail assembly comprises a configuration where the container and rails of the rail assembly are permanently and inseparably fixed together creating a container and rail assembly unit, where the rail assembly includes coupling mechanisms at each end of its rails, whereby, said coupling mechanisms provide means of attachment between two or more container and rail assembly units, thus capable of creating a chain of container and rail assembly units, where the coupling mechanism envisions any form of reversibly attaching configuration such as, but not limited to, hinge attachment, hook attachment, pin attachment, magnetism, adhesive, etc.

7. The container and rail assembly that is essentially what is claimed in claim 1 through 5, characterized in that said container and rail assembly comprises a configuration where the container and rails of the rail assembly are separate and distinct components of the container and rail assembly unit, where the containers may be reversibly removed or inserted into the rails of the rail assembly even while the rail assembly is affixed to a surface.

8. A container and rail assembly system (the “container system”) that is essentially what is claimed in claim 1, characterized in that said container system includes the use of multiple container and rail assembly units, whether permanently fixed units as claimed in claim 6 or reversibly separable units as claimed in claim 7, where said container and rail assembly units are affixed to a surface and adjacent to each other as contemplated under the permanently fixed unit embodiment, or where said units are reversibly connected to each other in chains of units that lie adjacent to each other as contemplated under the reversibly separable unit embodiment.

9. A method of situating said container and rail assembly from claim 1 within a structure so as to achieve maximum efficiency of the PCM within the container and rail assembly while also consuming minimal usable space of the structure, where the container and rail assembly is attached to the structure's walls, ceilings, floors, or other surfaces so that the container or rail assembly is largely in the unused area of the structure yet within the airflow of the air emanating from the air conditioning system, thereby allowing the efficacy of the PCM to be maximized while said container and rail assembly consumes largely unused space.
